(19) United States
(12) Patent Application Publication
(10) Pub. No.: US 2005/0132414 A1
(43) Pub. Date: Jun. 16, 2005

(54) Networked video surveillance system

(75) Inventors: Sheldon R. Bentley, Truckee, CA (US); Stephen D. Bristow, Los Altos Hills, CA (US); David G. Beck, Tiburon, CA (US)

Correspondence Address: PATENT LAW OFFICE OF DAVID G. BECK, P. O. BOX 1146, MILL VALLEY, CA, 94942, US

(73) Assignee: Connexed, Inc.

(21) Appl. No.: 10/990,720

(22) Filed: Nov. 17, 2004

Related U.S. Application Data
(60) Provisional application No. 60/526,121, filed on Dec. 2, 2003.

(51) Int. Cl. H04N 7/18

(52) U.S. Cl. 725/105; 348/143

(57) ABSTRACT

A method of storing, analyzing and accessing video data from the surveillance cameras operated by multiple, unrelated users is provided. Data storage and analysis is performed by an independent system remotely located at a third party site, the third party site and the users connected via a network. Users access stored video data using any of a variety of devices coupled to the network. In one aspect, users submit configuration instructions which govern how long their data is to be stored, the frequency of data acquisition/storage, data communication parameters/protocols, and video resolution. In another aspect, users remotely obtain from the third party system a graphical view of the video data acquired from a particular camera, the graphical view showing the activity monitored by the camera versus time. In yet another aspect, users submit zone configuration instructions to the third party system. In yet another aspect, users remotely submit rules of analysis, such as time-based and/or shaped-based rules, to be applied to their acquired video data by the third party system.

### CROSS-REFERENCES TO RELATED APPLICATIONS

This application claims priority of U.S. Provisional Patent Application Ser. No. 60/526,121, filed Dec. 2, 2003, the disclosure of which is incorporated herein by reference for any and all purposes.

### FIELD OF THE INVENTION

The present invention relates generally to surveillance systems and, more particularly, to a method for remotely storing and analyzing surveillance camera video data.

### BACKGROUND OF THE INVENTION

Due to the increased belief by businesses and individuals alike that a burglar alarm system is a necessity, considerable time and effort has been placed on the development of a variety of different types of security systems. One of the most common types of security systems employ simple trip switches to detect intruders. The switches range from door and window switches to relatively sophisticated motion detectors employing IR, ultrasonic and other means to detect motion in their field of view. These systems typically include a simple means of arming/disarming the system, e.g., a key or keypad, and a horn, bell or similar means that alerts people in the vicinity of the alarm while hopefully frightening the intruder away.

In order to eliminate the dependence on other people reporting to police a ringing alarm, newer security systems use alarm monitoring companies to monitor the status of their alarms and report possible security breaches to the authorities. Typically the on-premises alarm system is coupled to the central monitoring by phone lines. When the on-premises alarm detects a possible security breach, for example due to the tripping of a door switch or detection by a motion detector, it automatically dials up the monitoring company and reports its status. Depending upon system sophistication, it may also report which alarm switch was activated. A human operator then follows the monitoring company's procedures, for example first calling the owner of the alarm system to determine if the alarm was accidentally tripped. If the operator is unable to verify that the alarm was accidentally tripped, they typically call the local authorities and report the possible breach. Recent versions of this type of security system may also have RF capabilities, thus allowing the system to report status even if the phone lines are inoperable. These security systems also typically employ back-up batteries in case of a power outage.

Properties requiring greater security, such as banks or commercial retail stores in which petty theft is common, often augment or replace traditional security systems with surveillance camera systems. The video images acquired by the surveillance cameras is typically recorded on-site, for example using either magnetic tape recorders (e.g., VCRs) or digital recorders (e.g., DVD recorders). In addition to recording the output from the surveillance cameras, high end video-based security systems employ security personnel to monitor the camera output 24 hours a day, 7 days a week. Lower end video-based security systems typically do not utilize real-time camera monitoring, instead reviewing the recorded camera output after the occurrence of a suspected security breach. As the video data in either of these systems is typically archived on-premises, the data is subject to accidental or intentional damage, for example due to on-site fire, tampering, etc.

Typical prior art video-based security systems capture images without regard to content. Furthermore the video data, once recorded, is simply archived. If the data must be reviewed, for example to try and determine how and when a thief may have entered the premises in question, the recorded video data must be painstakingly reviewed, minute by minute. Often times the clue that went unnoticed initially continues to elude the data reviewers, in part due to the amount of imagery that the reviewer must review to find the item of interest which may last for no more than a minute.

The advent of the internet and low priced digital surveillance cameras has lead to a new form of video surveillance, typified by the “nanny cam” system. The user of such a system couples one or more digital surveillance cameras to an internet connected computer and then, when desired, uses a second internet connected computer to monitor the output from the surveillance cameras. Although such systems offer little protection from common theft as they require continuous monitoring, they have been found to be quite useful for people who wish to periodically visually check on the status of a family member.

Although a variety of video-based security systems have been designed, these systems typically are limited in their data handling capabilities. Accordingly, what is needed in the art is a video-based security system in which captured video images can be remotely analyzed and stored. The present invention provides such a system.

### SUMMARY OF THE INVENTION

The present invention provides a method of storing, analyzing and accessing video data from the surveillance cameras operated by multiple, unrelated users. Data storage and analysis is performed by an independent system remotely located at a third party site, the third party site and the users connected via a network. Preferably the network is the internet. Users access stored video data using any of a variety of devices coupled to the network.

In one embodiment of the invention, users submit configuration instructions to the third party system. The submitted configuration instructions govern how long their data is to be stored, the frequency of data acquisition/storage, data communication parameters/protocols, and video resolution. Preferably the configuration instructions are camera specific.

In another embodiment of the invention, users remotely obtain from the third party system a graphical view of the video data acquired from a particular camera, the graphical view showing the activity monitored by the camera versus time. In addition to identifying the camera of interest, the user preferably identifies the time period of interest. Based on the graphical representation of monitored activity, the user can then highlight a specific time period for detailed review. In response, the third party system transmits to the user the video data acquired from the identified camera for the time of interest.

In yet another embodiment of the invention, users submit zone configuration instructions to the third party system. The submitted zone configuration instructions govern how to divide each camera's field of view into multiple zones. Preferably the zone configuration instructions also govern the size of the zones as well as their locations within the field of view. Division of a camera's field of view allows the user to set-up different rules of analysis for each of the zones.

In yet another embodiment of the invention, users remotely submit rules of analysis to be applied to their acquired video data by the third party system. The submitted rules can apply to specific cameras or all of the user's cameras. Additionally the rules can apply either to a camera's entire field of view, or different rules can apply to different zones within the camera's field of view. The submitted rules of analysis can be time-based and/or shape-based.

A further understanding of the nature and advantages of the present invention may be realized by reference to the remaining portions of the specification and the drawings.

### BRIEF DESCRIPTION OF THE DRAWINGS

FIG. 1 is an illustration of a video surveillance system according to the prior art;

FIG. 2 is an illustration of a second prior art video surveillance system utilizing the internet to provide the user with access to camera data;

FIG. 3 is an illustration of an embodiment of the invention utilizing a central video data storage and handling site;

FIG. 4 is an illustration of an embodiment of the invention utilizing an on-site data system;

FIG. 5 is an illustration of an exemplary data screen that allows the user to assign data storage periods for each camera;

FIG. 6 is an illustration of a graphical activity timeline screen;

FIG. 7 is an illustration of a screen containing multiple camera fields of view;

FIG. 8 is an illustration of a camera's field of view divided into three zones;

FIG. 9 is an illustration of a geochronshape rule data entry screen;

FIG. 10 is an illustration of a geochronshape rule data entry screen that includes autozoom features;

FIG. 11 is an illustration of a geochronshape rule data entry screen that includes autofocus features;

FIG. 12 is an illustration of a screen containing multiple camera fields of view and autoflagging features;

FIG. 13 is an illustration of an action overview screen;

FIG. 14 is an illustration of an action log screen;

FIG. 15 is an illustration of an alternate embodiment of the invention that provides multiple means of user notification as well as user interrogation features; and

FIG. 16 is an illustration of a notification rule data entry screen.

### DESCRIPTION OF THE SPECIFIC EMBODIMENTS

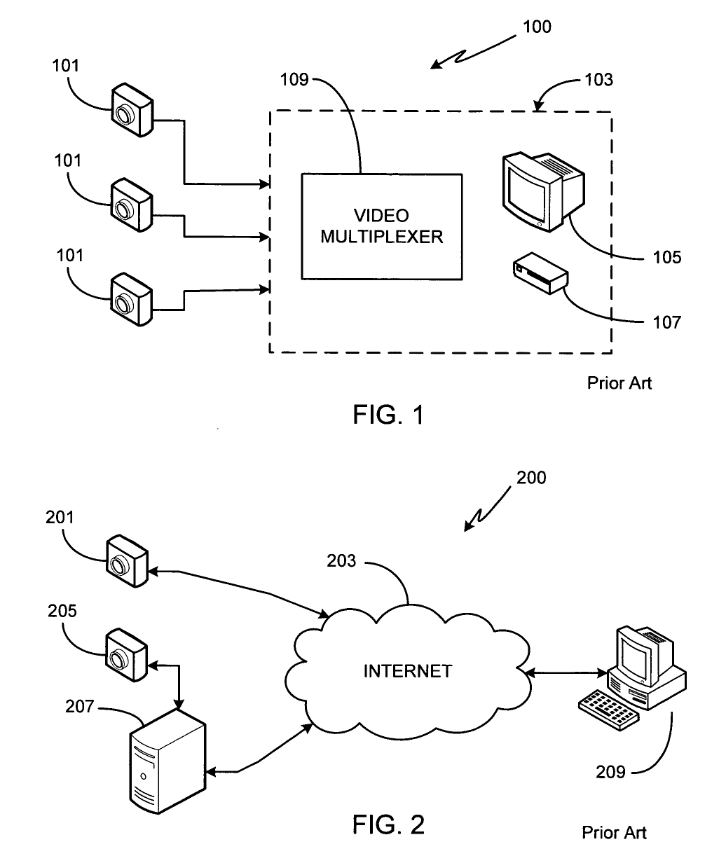

FIG. 1 is an illustration of a prior art video surveillance system 100 often used in stores, banks and other businesses. The system includes at least one, and preferably multiple, cameras 101. The output from each camera 101 is sent, typically via hard wire, to a monitoring/data base system 103. Monitoring/data base system 103 includes at least one monitor 105 and at least one data base system 107. Data base system 107 typically uses either a video cassette recorder (VCR) or a CD/DVD recorder, both recorders offering the ability to store the data acquired by cameras 101 on a removable medium (i.e., tape or disc). Monitoring/data base system 103 may also include one or more video multiplexers 109, thus allowing the data (images) captured by cameras 101 to be shown on fewer monitors 105 and/or recorded on fewer recorders 107. Depending upon the requirements placed on surveillance system 100 by its users, the data acquired by cameras 101 may be under continual scrutiny, for example by one or more security personnel viewing monitor 105, or only reviewed when necessary, for example after the occurrence of a robbery or other security breaching event.

FIG. 2 is an illustration of a second prior art video surveillance system 200 utilizing the internet to provide the user with access to camera data. The system includes one or more cameras. In one instance the cameras (e.g., camera 201) have the ability to directly connect to internet 203, for example via a standard phone line or DSL line or with a wireless link. Alternately, the cameras (e.g., camera 205) can be coupled to a computer 207 or other means that can format (e.g., digitize, compress, etc.) the output of camera 205 and then transmit the formatted camera output over internet 203. The user is able to retrieve, view and store the output from cameras 201 and/or 205 by linking a computer 209 to internet 203. Computer 209 may use either an internal or external modem or Ethernet adaptor to link to internet 203. The acquired camera video is stored on an internal hard drive, an external hard drive or removable media associated with computer 209. As computer 209 is required to retrieve the video data from cameras 201 and/or 205, it must remain on and connected to internet 203 whenever camera data storage is desired.

System Configuration

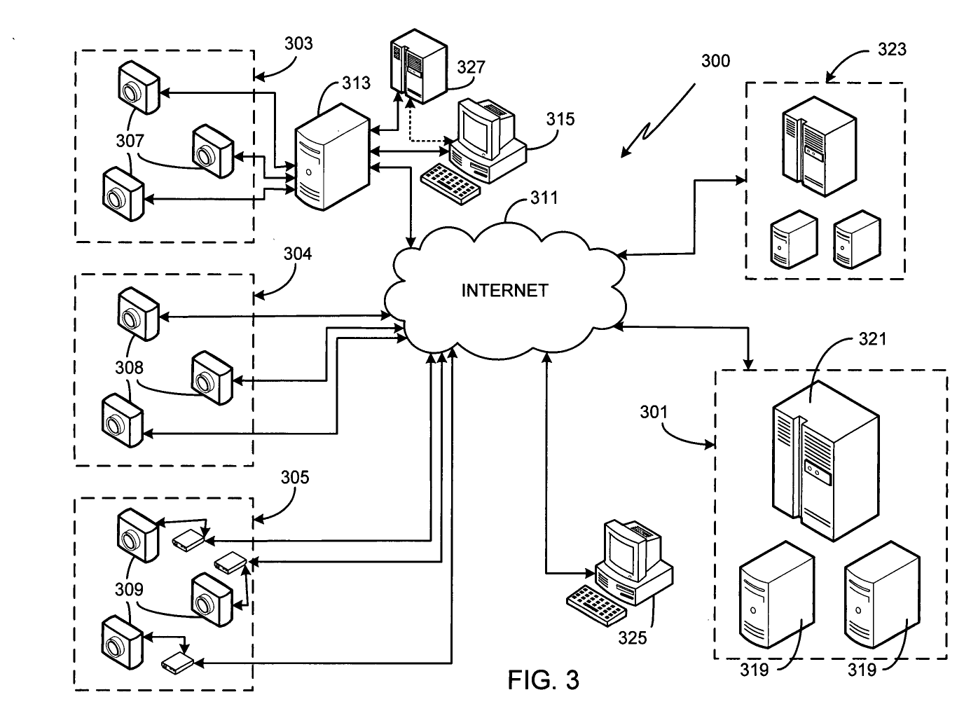

FIG. 3 illustrates a preferred embodiment 300 of the invention. This embodiment, as with other embodiments of the invention, utilizes a third party site 301 to store and handle the video data acquired by multiple users. The users may be affiliated or unrelated, e.g., unrelated, independent companies.

Third party site 301 is remotely located from the users, thus eliminating the need for on-site storage by providing each of the users with a safe, off-site video data storage location. Since site 301 is under third party control and is located off-premises, the risk of an accident (e.g., fire) or an intentional act (e.g., tampering by a disgruntled employee) from damaging or destroying the stored data is greatly reduced. Additionally, as site 301 is a dedicated storage/handling site, redundant storage systems can be used as well as more advanced data manipulation systems, all at a fraction of the cost that a single user would incur to achieve the same capabilities.

As previously noted, third party site 301 stores/manipulates the video data from multiple users. Although FIG. 3 only indicates three individual users 303-305, it will be appreciated that users 303-305 are only representative users and that system 300 can be designed to handle as many users as desired. One or more cameras 307-309 are employed at each user's site. The video data from each user is sent to third party site 301 via internet 311. It should be appreciated that there are countless methods of coupling the individual cameras 307-309 to internet 311 and that the invention is not limited to one or more specific methods. For illustrative purposes only, FIG. 3 shows three exemplary methods. Cameras 307 of user 303 are each coupled to a local area network (LAN) 313 which is, in turn, connected to internet 311. If desired, a local monitoring station 315 can be connected to LAN 313, thus allowing real-time review of video data prior to, or simultaneously with, storage and data processing at site 301. Alternately a user (e.g., user 304) can utilize cameras 308 each of which are capable of direct connection, wired or wireless, to internet 311. Alternately a user (e.g., user 305) can utilize cameras 309 in conjunction with modems 317 to connect to internet 311.

One or more servers 319 and one or more storage devices 321 are located at third party site 301. Servers 319 are used to process the video data received via internet 311 from users 303-305 as described more fully below. Additionally servers 319 control the user interface as described more fully below. Preferably servers 319 also perform the functions of system maintenance, camera management, billing/accounting, etc. The required applications can be drafted using Java, C++ or other language and written to work in an operating system environment such as provided by the Linux, Unix, or Windows operating systems. The applications can use middleware and back-end services such as those provided by data base vendors such as Oracle or Microsoft.

Storage devices 321 can utilize removable or non-removable medium or a combination thereof. Suitable storage devices 321 include, but are not limited to, disks/disk drives, disk drive cluster(s), redundant array of independent drives (RAID), or other means.

If desired, one or more additional third party sites 323 can be coupled to the first third party site 301 via internet 311. Preferably additional third party sites 323 are geographically located at some distance from the first third party site 301, thus providing system redundancy at a location that is unlikely to be affected by any system disturbance (e.g., power outage, natural disaster, etc.) affecting site 301.

Preferably the user accesses the video data stored at site 301 via internet 311 using any of a variety of devices. As described more fully below, depending upon the type of requested data and depending upon whether the user is initiating contact (e.g., data review) or is being contacted by the site 301 system (e.g., alarm notification), the user can use any of a variety of different communication means. In FIG. 3 a desktop computer 325 is shown connected to internet 311, the connection being either wired or wireless.

It will be appreciated that although not shown, typically a firewall is interposed between internet 311 and each connected system, thus providing improved system security.

Preferably data compression is used to minimize storage area on drives 321 and to simplify data transmission between site 301 and an end user (e.g., desktop computer 325). If desired, a portion of, or all of, the data compression can be performed prior to transmitting the data from a user to the internet. For example, a processor within or connected to LAN 313 can compress the data from cameras 307 prior to transmission to internet 311. A benefit of such an approach is that it allows either more images per second to be uploaded to site 301 over a fixed bandwidth connection or a lower bandwidth connection to be used for a given frame per second rate. Alternately, or in addition to such pre-transmission compression, server 319 can be used to filter and compress the captured video data. In at least one preferred embodiment, server 319 compresses the video data after it has been augmented (e.g., text comments added to specific data frames), manipulated (e.g., combining multiple camera feeds into a single data stream), organized (e.g., organized by date, importance, etc.) or otherwise altered. The degree of data compression can vary, for example depending upon the importance attributed to a particular portion of video data or the resolution of the acquired data. Importance can be determined based on camera location, time of day, event (e.g., unusual activity) or other basis. Data compression can utilize any of a variety of techniques, although preferably an industry standardized technique is used (e.g., JPEG, MPEG, etc.).

In an alternate embodiment, one or more of the users may utilize local, on-premises data storage in addition to the data storage, manipulation and analysis provided by third party site 301. For example as shown in FIG. 3, the system of user 303 can also include data storage means 327 coupled to LAN 313. Depending upon the sophistication of data storage means 327, i.e., a simple memory device versus a memory device within a data processing/manipulation system, data storage means 327 can also be coupled to, or integrated within, local monitoring station 315 (note that the coupling to 327 is shown in phantom). Data storage means 327 provides storage redundancy for user 303 and similarly equipped users. It also provides such users with rapid, on-site access to stored data, an aspect that some users may desire.

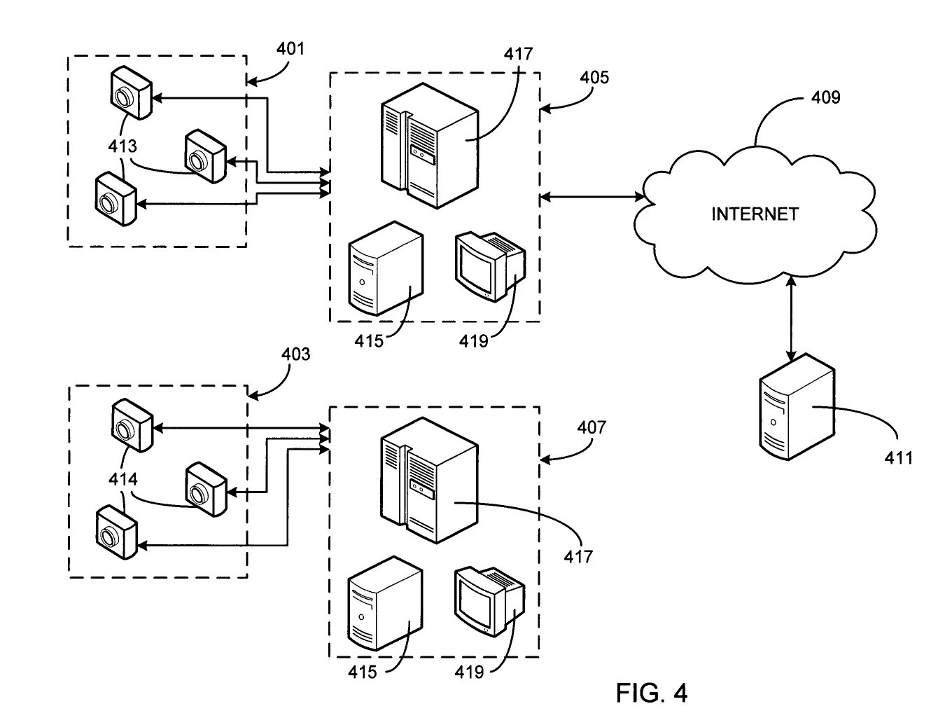

Although as previously described the preferred embodiment of the invention utilizes an off-site location under third party control to store, analyze and manipulate video data from multiple users, it should be appreciated that many of the benefits of the present invention can also be incorporated into a video handling system that is located and operated by a single user. For example, the desired data handling functions offered by the present invention can be integrated into the system of user 303 shown in FIG. 3, utilizing LAN 313, storage device 327 and processing/monitoring station 315. Alternately the on-site data system can operate independently of any off-site data storage means, for example as illustrated in FIG. 4. FIG. 4 illustrates two separate users 401 and 403 utilizing independent, self-contained data storage and handling systems 405 and 407, respectively. System 405 is coupled to internet 409, thus allowing it to acquire the desired video handling software, software updates and integration aid from third party server 411, also coupled to internet 409. In contrast system 407 is not coupled to internet 409, thus requiring data handling software to be acquired and installed using a non-internet based means (e.g., disk). It will be appreciated that both systems 405 and 407 are coupled to cameras 413 and 414, respectively, and include application/processing servers 415, data storage means 417, and user monitoring stations 419.

Data Storage Allocation

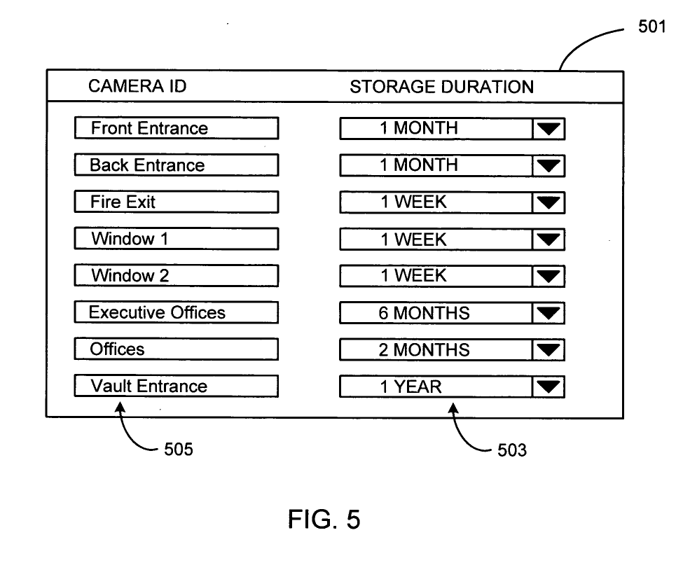

As previously described, in the preferred embodiment video data acquired by multiple users is sent via the internet to an independent third party site for storage. As one possible billing scenario is to charge users based on their individual data storage requirements, in one embodiment of the invention users are allowed to configure the system as desired. The data acquisition and storage attributes that are preferably user configurable include storage time (i.e., how long data is to be maintained) and data transmission/acquisition frequency (i.e., how often data is acquired and transmitted to the storage site). As such parameters are typically camera specific, in the preferred embodiment each camera can be independently configured. Thus, for example, video data from a high priority camera (e.g., bank vault entrance, cash register, etc.) can be frequently acquired/stored and maintained in storage for a long period while video data from a low priority camera (e.g., hallway, etc.) can be acquired/stored less frequently and maintained in storage for a shorter period. FIG. 5 illustrates an exemplary data screen 501 that allows the user to assign data storage periods 503 for each of the user's cameras 505. For simplicity, the user is allowed to select the storage period from a drop-down menu. It will be appreciated that although not shown in FIG. 5, preferably the user is also allowed to configure other rules relating to data acquisition and storage including, but not limited to, data acquisition frequency, data communication parameters (e.g., data rate, communication protocols, etc.), and video resolution. The last parameter, video resolution, is useful since in some instances a camera is only being used to monitor for activity (e.g., door openings) while in other instances a camera is recording details (e.g., bank transactions, gambling transactions, etc.).

Since the video data captured by the user's cameras are transmitted over the internet or similar network to the independent third party site as described herein, the amount of data that can be transferred is dependent upon the available bandwidth of the transmission link. As such bandwidth may vary over time as is well known by those of skill in the art, at any given time the bandwidth of the link may be insufficient to transfer the desired amount of data. For example, a user may want all captured video data to be high resolution. If the transmission bandwidth drops sufficiently, however, in order to transmit the desired resolution a complete set of images may only be transmitted once every thirty minutes, thus leaving large blocks of time unrecorded. In order to overcome such a problem, in at least one embodiment of the invention the third party site varies one or more transmission variables (e.g., frame rate, compression ratio, image resolution, etc.) in response to bandwidth variations, thereby maximizing the usefulness of the transmitted data. The set of instructions that governs which variables are to be adjusted, the order of adjustment, the limitations placed on adjustment, etc. can either be user configured or third party configured.

Data Review Aids

The present invention provides a variety of techniques that can be used to quickly and efficiently review and/or characterize acquired video data regardless of where the video data is stored (e.g., at third party site 301 or a user location). It will be appreciated that some, all, or none of the below-described aids may be used by a particular user, depending upon which system attributes are offered as well as the user's requirements (e.g., level of desired security, number of cameras within the user's system, etc.).

The description of the data review aids provided below assumes that the user has input their basic camera configuration (e.g., number of cameras, camera identifications, camera locations) and system configuration (e.g., communication preferences and protocols) into the system.

Timeline Activity

The timeline activity aid provides a user with an on-line graphical view of one or more of the user's cameras for a user selected date and period of time. Thus, for example, user 304 can query third party system 301 via computer 325 or other means, requesting to view the activity for a selected period of time and for one or more of the user's cameras. In response to such a query, third party system 301 would provide user 304 with the requested data in an easily reviewable graphical presentation. If the user finds an anomaly in the data, or simply decides to review the actual video data from one of the cameras in question, the user can do so by inputting another query into system 301. In a preferred embodiment of the invention, the user can input their second query by placing the cursor on the desired point in a particular camera's timeline using either “arrow” keys or a mouse, and then selecting the identified portion by pressing “enter” or by clicking a mouse button. Third party system 301 then transmits the designated video sequence to the user via internet 311.

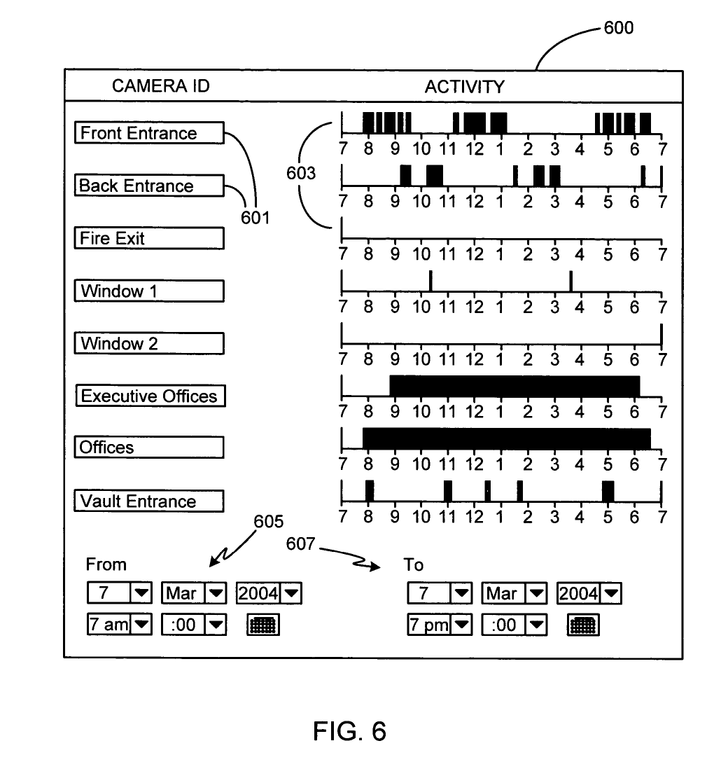

FIG. 6 illustrates one possible screen 600 that the graphical activity timeline can use. As shown, the identity 601 of each selected camera is provided as well as the activity timeline 603 for each camera. The user selects both the starting date and time (e.g., pull-down menus 605) and the ending date and time (e.g., pull-down menus 607). For purposes of this embodiment, activity is represented by a spike on an activity timeline 603, activity being defined as a non-static image, e.g., an image undergoing a relatively rapid change in parameters. For example, a spike in an activity timeline 603 can indicate that the camera in question recorded some movement during the identified time. As techniques for comparing captured frames of video data to one another are well known by those of skill in the art, as are techniques for setting differentiation thresholds for the two frames, detailed description of such techniques are not provided herein.

The primary benefit of the activity timeline is that it allows a user to quickly review acquired video data without actually viewing the video data itself. This is especially important for those users, for example large companies, that may employ hundreds of surveillance cameras. Security personnel, either viewing camera data real-time or from records, may be so overwhelmed with data that they miss a critical security breach. In contrast, the present invention allows a single person to quickly review hours, days or weeks of data from hundreds of cameras by simply looking for unexpected activity. For example, it would only take security personnel reviewing the data presented in FIG. 6 seconds to note that at 7 pm the back entrance, second window and vault cameras all showed activity. Assuming that such activity was unexpected, the security personnel could then review the video data acquired by each of the cameras to determine if, in fact, a security breach had occurred.

In an alternate embodiment of this aspect of the invention, the user can request to view the activity timeline only for those cameras recording activity during a user selected period of time. Thus, for example, if the user with the data illustrated in FIG. 6 requested to view the timeline for any camera which recorded activity at 7 pm on Mar. 7, 2004, only activity timelines for the back entrance, second window and vault entrance cameras would be presented. This capability is especially helpful when the user has hundreds of cameras.

Video View Set-Up

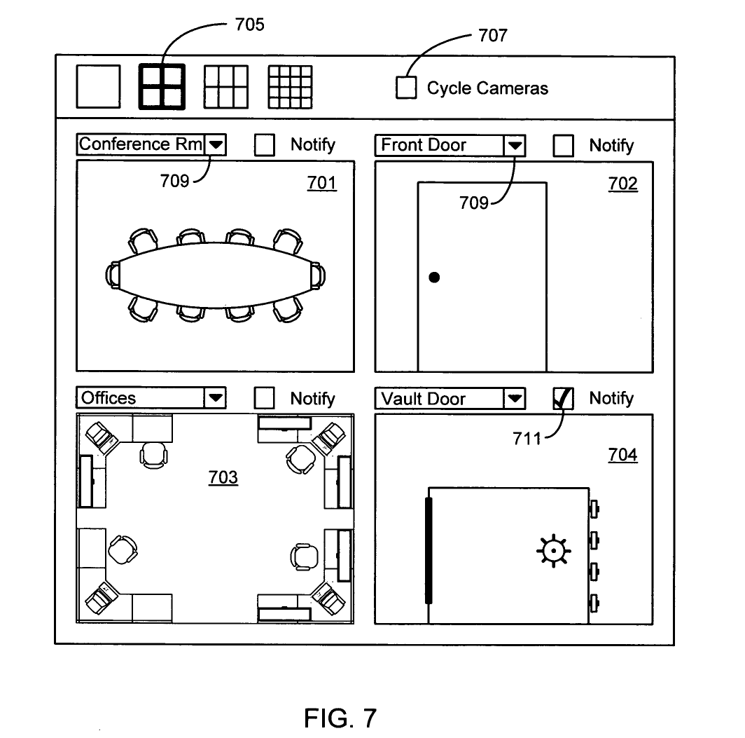

In another aspect of the invention the user can individualize the form that video data is to be presented. For example as shown in FIG. 7, the user selects the number of video images 701-704 to be presented on a single screen by highlighting, or otherwise identifying, the desired number of camera images to be simultaneously viewed (e.g., four screen ‘button’ 705 is highlighted in FIG. 7). The user can also select whether or not to cycle the camera images through the presented windows (e.g., ‘button’ 707). In this embodiment the user can also select, via pull-down menus 709, which camera images are to be presented in each of the screen's selected window panes.

In addition to allowing a user to individualize camera image presentation, in the preferred embodiment of the invention the user can select (via ‘button’ 711 or similar means) whether or not they wish to be notified when motion is detected on a particular camera. This aspect of the invention can be used either while viewing camera data real-time or viewing previously recorded video data. Thus, for example, a user can request notification for those cameras in which activity is not expected, or not expected for a particular time of day. Notification can be by any of a variety of means including, but not limited to, audio notification (e.g., bell, pre-recorded or synthesized voice announcements which preferably include camera identification, etc.), video notification (e.g., highlighting the camera image in question, for example by changing the color of a frame surrounding the image, etc.), or some combination thereof.

Geochronshape Rules

In another aspect of the invention, the user is able to set-up a sophisticated set of rules that are applied to the acquired camera images and used for flagging images of interest. The flags can be maintained as part of the recorded and stored video data, thus allowing the user at a later time to review data that was identified, based on the geochronshape rules, to be of potential interest. Alternately, or in addition to flagging the stored data, the flags can also be used as part of a notification system, either as it relates to real-time video data or video data that has been previously recorded.

In the preferred embodiment, the user is able to divide an image into multiple zones (the “geo” portion of the geochronshape rules) and then set the rules which apply to each of the identified zones. The rules which can be set for each zone include time based rules (the “chron” portion of the geochronshape rules) and shape based rules (the “shape” portion of the geochronshape rules).

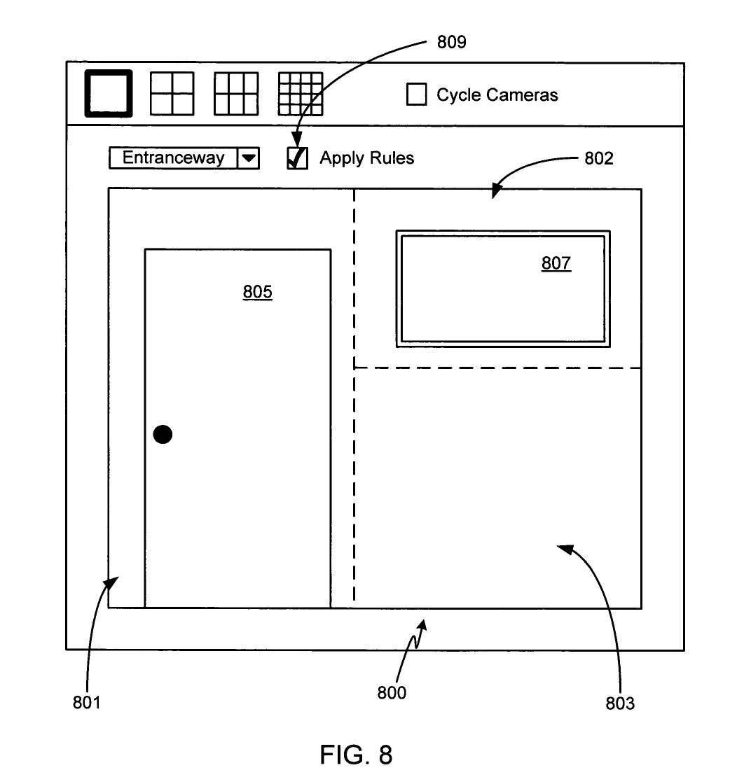

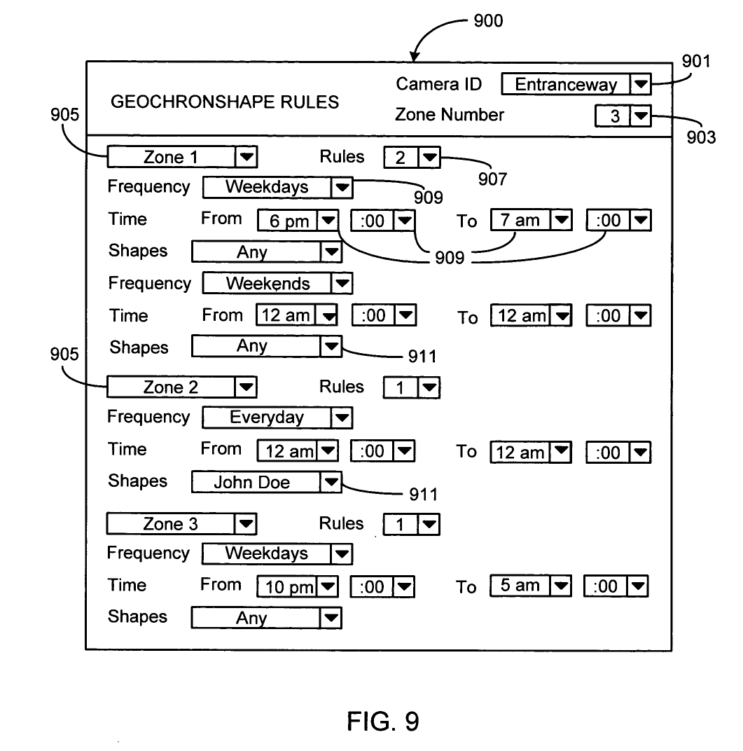

As previously noted, using this aid the user identifies specific areas or zones within a particular camera's field of view to which specific rules are applied. For example, FIG. 8 is an illustration of a camera's field of view 800 that the user has divided into three zones 801-803. Zone 801 includes entrance door 805, zone 802 includes outside window 807, and zone 803 includes a portion of a hallway. Preferably the user selects, per camera, whether or not to apply the geochronshape rules, for example by selecting button 809 as shown. It is understood that although the screen in FIG. 8 shows a single camera's field of view 800, the screen could be divided into multiple camera images, for example as described above with respect to FIG. 7. A separate data input screen 900 shown in FIG. 9 provides the user with a means of entering the rules for each zone. It will be appreciated that screen 900 is only meant to be illustrative of one type of data input screen and is not intended to limit either the types of rules or the manner in which they can be input into the system.

When the user inputs zone rules into screen 900, the user must first select the camera ID to which the rules apply (e.g., pull-down menu 901) and the total number of zones that are to be applied to that camera (e.g., pull-down menu 903). For each these zones, identified by a pull-down menu 905, the user selects the number of rules to be applied (e.g., pull-down menu 907). The user can then select when the rules apply using pull-down menus 909. For example in the data shown in FIG. 9, zone 1 has two rules, one applicable on weekdays from 6 pm to 7 am and the second applicable 24 hours a day on weekends. As illustrated, zone 2 is active 24 hours a day, every day, while zone 3 is only active on weekdays from 10 pm to 5 am. With respect to shapes, pull-down menu 911 is used to select the shape of the object to be detected. Preferably the user can select both from system shapes and from user input shapes. For example, typically the system includes an “any” shape, thus allowing notification to occur if any object, regardless of shape or size, is detected within the selected period of time. Thus in this example the zone 1 rules are set to determine if there is any movement, such as the opening of door 805, from 6 pm to 7 am (i.e., rule 1 for zone 1) or at anytime during the weekend (i.e., rule 2 for zone 1). The system shapes may also include size shapes, thus allowing the user to easily allow small objects (e.g., cats, dogs, etc.) to enter the zone without causing a detection alarm by the system. User input shapes may include people or objects that are of particular concern (e.g., a particular person, a gun shape in a banking facility, etc.). In this example the zone 2 rules are set to detect if a particular person (i.e., John Doe) passes window 807 at any time.

It will be appreciated that although the preferred embodiment of the invention includes zone, time and shape rules as described above (i.e., geochronshape rules), a particular embodiment may only include a subset of these rules. For example, the system can be set-up to allow the user to simply select zones from a preset number and location of zones (e.g., split screen, screen quadrants, etc.). Alternately, the system can be set-up to only allow the user to select zone and time, without the ability to select shape. Thus in such a system any motion within a selected zone for the selected time would trigger the system. It is understood that these are only a few examples of the possible system permutations using zone, time and shape rules, and that the inventors clearly envision such variations.

Autozoom

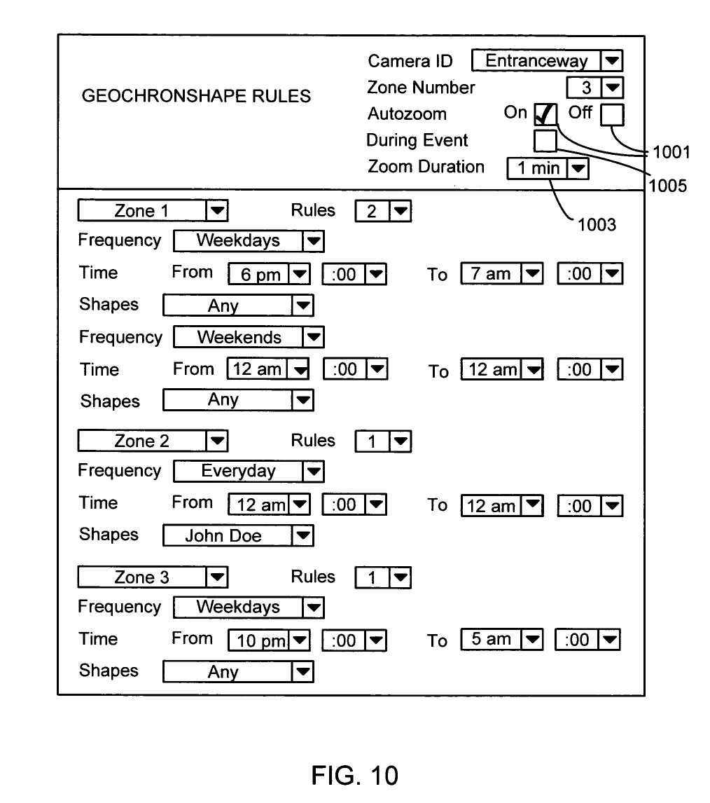

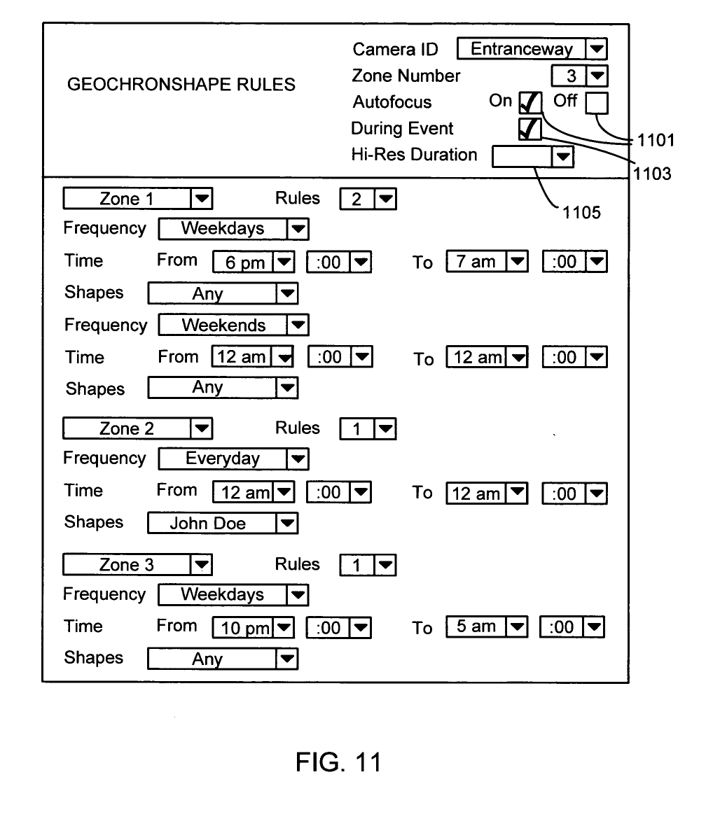

In another aspect of the invention, the user is able to select an autozoom feature that operates in conjunction with the geochronshape rules described above. Typically the user selects this feature on the geochronshape rules screen, as illustrated in FIG. 10, although it should be understood that the user may also select such a feature on another data input screen, for example a data input screen which allows the user to select the features to be applied to all of their captured video data. The screen example shown in FIG. 10 is identical to that shown in FIG. 9, with the addition of autozoom selection buttons 1001, 1003 and 1005.

When the autozoom function is selected, as in FIG. 10, the camera zooms in on a particular zone whenever a geochronshape rule associated with that zone is triggered. Camera zoom can operate in a variety of ways, depending upon how the system is set-up. Preferably when the autozoom feature is triggered, the camera automatically repositions itself such that the zone of interest is centered within the camera's field of view, then the camera zooms in until the zone in question completely fills the camera's field of view. Alternately, the camera can automatically reposition itself to center the zone of interest, and then zoom in by a preset amount (e.g., 50%).

Camera repositioning, required to center the zone of interest in the camera's field of view, can be performed either mechanically or electronically, depending upon a particular user's system capabilities. For example, one user may use cameras that are on motorized mounts that allow the camera to be mechanically repositioned as desired. Once repositioned, this type of camera will typically use an optical zoom to zoom in on the desired image. Alternately, a user may use more sophisticated cameras that can be repositioned electronically, for example by selecting a subset of the camera's detector array pixels, and then using an electronic zoom to enlarge the image of interest.

Preferably after zooming in on the zone which had a triggering event (e.g., motion), the camera will automatically return to its normal field of view rather than staying in a ‘zoom’ mode. The system can either be designed to remain zoomed in on the triggering event until it ceases (e.g., cessation of motion, triggering shape moving out of the field of view, etc.) or for a preset amount of time. The latter approach is typically favored as it both insures that a close-up of the triggering event is captured and that events occurring in other zones of the image are not overlooked. In the screen illustrated in FIG. 10, once the user selects the autozoom feature, they also set either a duration time from a pull-down menu (e.g., button 1003), or event monitoring (e.g., button 1005).

Autofocus

In another aspect of the invention, the user is able to select an autofocus feature that operates in conjunction with the geochronshape rules described above. As opposed to a photography/videography autofocus system in which the lens is automatically adjusted to bring a portion of an image into focus, the autofocus feature of the current invention alters the resolution of a captured image. Typically the user selects this feature on the geochronshape rules screen, as illustrated in FIG. 11, although it should be understood that the user may also select such a feature on another data input screen, for example a data input screen which allows the user to select the features to be applied to all of their captured video data. The screen example shown in FIG. 11 is identical to that shown in FIG. 9, with the addition of autofocus selection buttons 1101, 1103 and 1105.

When the autofocus function is selected, as in FIG. 11, the camera increases the resolution whenever an event triggers one of the geochronshape rules. The system can either be set-up to increase the resolution of the entire field of view or only the resolution in the zone in which the triggering event occurred. Preferably the system is set-up to allow the user to either maintain high resolution as long as the triggering even is occurring, through the selection of the event button 1103 as illustrated, or for a set period of time (e.g., by selecting a time using pull-down menu 1105).

One of the benefits of the autofocus feature is that it allows image data to be transmitted and/or stored using less expensive, low bandwidth transmission and storage means most of the time, only increasing the transmission and/or the storage bandwidth when a triggering event occurs.

Autoflag

The autoflag feature is preferably used whenever the monitored image includes multiple fields of view such as previously illustrated in FIG. 7. The autoflag feature insures that the user does not miss an important event happening in one image while focusing on a different image. For example, a security guard monitoring a bank of camera images may be focused on a small fire occurring outside the building within the view of an external camera, and not notice a burglary occurring at a different location.

Preferably the autoflag feature is used in conjunction with the geochronshape rules, thus allowing the user to set-up a relatively sophisticated set of rules which trigger the autoflag feature. The autoflag feature can also be used with a default set of rules (e.g., motion detection within a field of view).

The autoflag feature can be implemented in several ways with an audio signal, a video signal, or a combination of the two. For example, an audio signal (e.g., bell, chime, synthesized voice, etc.) can sound whenever one of the geochronshape rules is triggered. If a synthesized voice is used, preferably it announces the camera identification for the camera experiencing the trigger event. A geochronshape trigger can also activate a video trigger. Preferably the video indicator alters the frame surrounding the camera image in question, for example by highlighting the frame, altering the color of the frame, blinking the frame, or some combination thereof. In the preferred embodiment both an audio signal and a video signal are used as flags, thus insuring that the person monitoring the video screens is aware of the trigger and is quickly directed to the camera image in question.

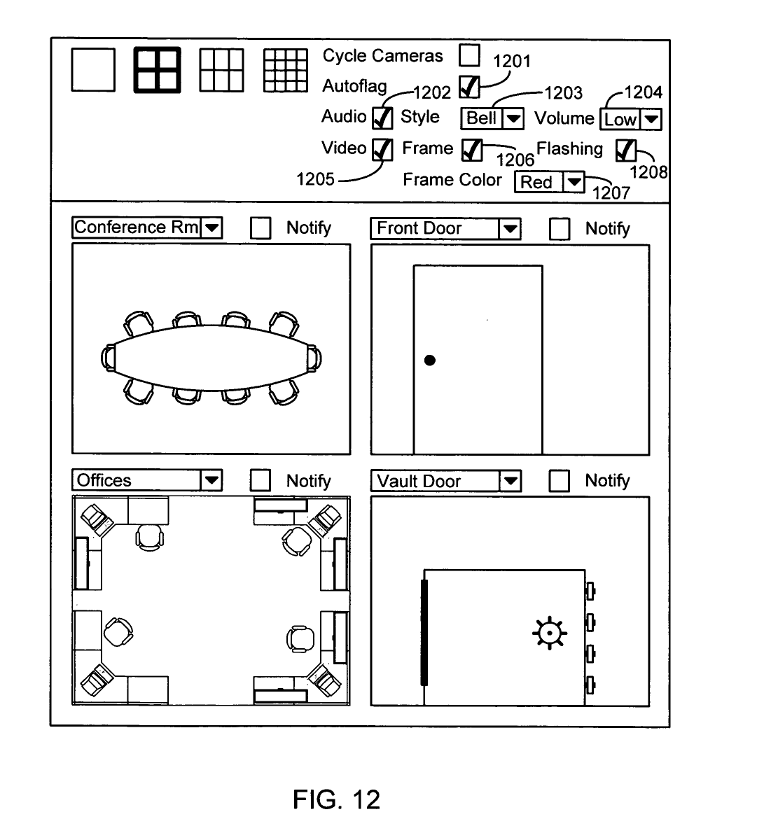

FIG. 12 is similar to FIG. 7 except for the addition of autoflag buttons 1201-1208. As with the other data review features, there are numerous ways to implement the autoflag feature. For example, the autoflag buttons could also be located on the geochronshape rules screen, a dedicated autoflag screen, a basic set-up screen or other screen. As shown in FIG. 12, the user selects the autoflag feature by highlighting button 1201. If the user selects to have an audio flag as indicated by the selection of button 1202, preferably the user can also set the indicator type (e.g., pull-down menu 1203) and volume (e.g., pull-down menu 1204). If the user selects to have a video flag as indicated by the selection of button 1205, preferably the user can also set-up specifics relating to the video flag (e.g., frame: button 1206; frame color: button 1207; flashing frame: button 1208; etc.).

Action Overview

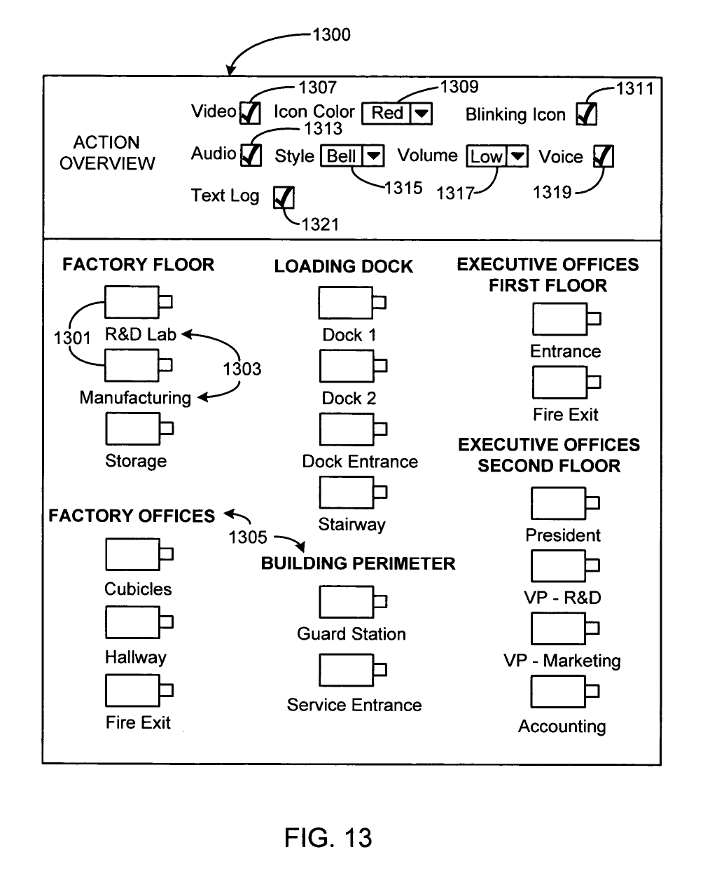

The action overview feature allows the user to simultaneously monitor hundreds of cameras. As illustrated in FIG. 13, an icon 1301 is used to indicate each camera. Associated with each camera icon is a camera identifier 1303, thus allowing rapid identification of a particular camera's location. Preferably the user is able to arrange the camera icons 1301 according to a user preference, thus achieving a logical arrangement. For example, in the illustration the icons are arranged by building and/or building area identifiers 1305 (e.g., factory offices, factory floor, loading docks, offices—1^{st} floor, offices—2^{nd} floor, fence perimeter, etc.).

Preferably the action overview feature is used in conjunction with the geochronshape rules, thus allowing the user to set-up a relatively sophisticated set of rules which trigger this feature. The action overview feature can also be used with a default set of rules (e.g., motion detection within a camera's field of view).

Regardless of whether the action overview feature is used in conjunction with the geochronshape rules, or a default set of rules, once a triggering event occurs the camera icon associated with the camera experiencing the triggering event changes, thus providing the user with a means of rapidly identifying the camera of interest. The user can then select the identified camera, for example by highlighting the camera and pressing “enter” or placing the cursor on the identified camera and double clicking with the mouse. Once selected, the image being acquired by the triggered camera is immediately presented to the user, thus allowing quick assessment of the problem.

The action overview feature can be implemented in several ways with a video signal, an audio signal, or a combination of the two. For example, the user can select video notification (e.g., button 1307), the color of the icon once triggered (e.g., pull-down menu 1309) and whether or not to have the icon blink upon the occurrence of a triggering event (e.g., button 1311). The user can also select audio notification (e.g., button 1313), the type of audio sound (e.g., pull-down menu 1315), and the volume of the audio signal (e.g., pull-down menu 1317). Preferably the user can also select to have a synthesized voice announce the location of the camera experiencing the triggering event. In the preferred embodiment both an audio signal and a video signal are used, thus insuring that the person monitoring the camera status screen is aware of the triggering event and is quickly directed to the camera image in question.

Action Log

The action log feature generates a textual message upon the occurrence of a triggering event, the triggering event either based on the previously described goechronshape rules or on a default set of rules (e.g., motion detection). This feature is preferably selected on one of the user set-up screens. For example, screen 1300 of FIG. 13 includes a text log button 1321 (shown as selected in FIG. 13) which is used to activate this feature.

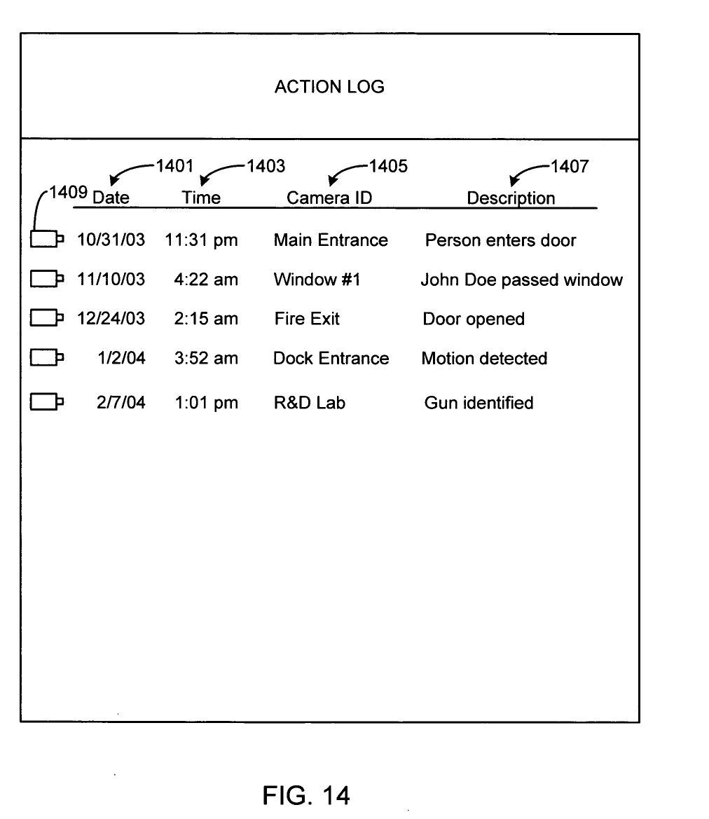

Once activated, the action log feature creates a text message for each triggering event, the messages being combined into a log that the user can quickly review. FIG. 14 illustrates a possible log in accordance with the invention. As shown, the log includes the event date 1401, the event time 1403 and the identification 1405 of the camera monitoring the triggering event. Depending upon the sophistication of the image recognition software used within the system, the log may also include a brief description 1407 of the event (e.g., door opened, entry of person after hours, etc.). In at least one embodiment, the description is added, or edited, by the system user after reviewing the event. In the preferred embodiment, the user can immediately view the image created in response to the triggering event, either by selecting the log entry of interest or selecting an icon 1409 adjacent to the log entry.

Notification System

In another aspect of the invention, a notification system is integrated into the third party site. There are a variety of ways in which the notification system can be implemented, depending upon both the capabilities of the third party site and the needs of the user. Depending upon implementation, the notification system allows the user, or someone designated by the user, to be notified upon the occurrence of a potential security breach (e.g., violation of a geochronshape rule) or other triggering event (e.g., loss of system and/or subsystem functionality such as a camera going off-line and no longer transmitting data). As described in further detail below, notification can occur using any of a variety of means (e.g., email, telephone, fax, etc.).

A number of benefits can be realized using the notification system of the invention. First, it allows a user to minimize personnel tasked with actively monitoring video imagery captured by the user's cameras since the notification system provides for immediate notification when a triggering event occurs. As a result, in at least one application security personnel can be tasked with other jobs (e.g., actively patrolling the area, etc.) while still being able to remotely monitor the camera system. Second, the system typically results in quicker responses to security breaches as the system can be set-up to automatically notify personnel who are located throughout the premises, thus eliminating the need for personnel monitoring the video cameras to first notice the security breach, decide to act on the breach, and then notify the roving personnel. Third, the system can be set-up to automatically send the user text descriptions of the triggering event (e.g., door opened on NE entrance, gun identified near vault, etc.) and/or video data (e.g., stills, video clip from the camera), thus allowing the user (e.g., security personnel) to handle the situation more intelligently (e.g., recognize the possible intruder, recognize the likelihood of the intruder being armed, etc.). Fourth, the system minimizes mistakes, such as mistakenly notifying the police department in response to a triggering event, by allowing for the immediate notification of high level personnel (e.g., head of security, operations manager, etc.) and/or multiple parties, thus insuring rapid and thorough review of the triggering event. Fifth, the system insures that key personnel are immediately notified of triggering events.

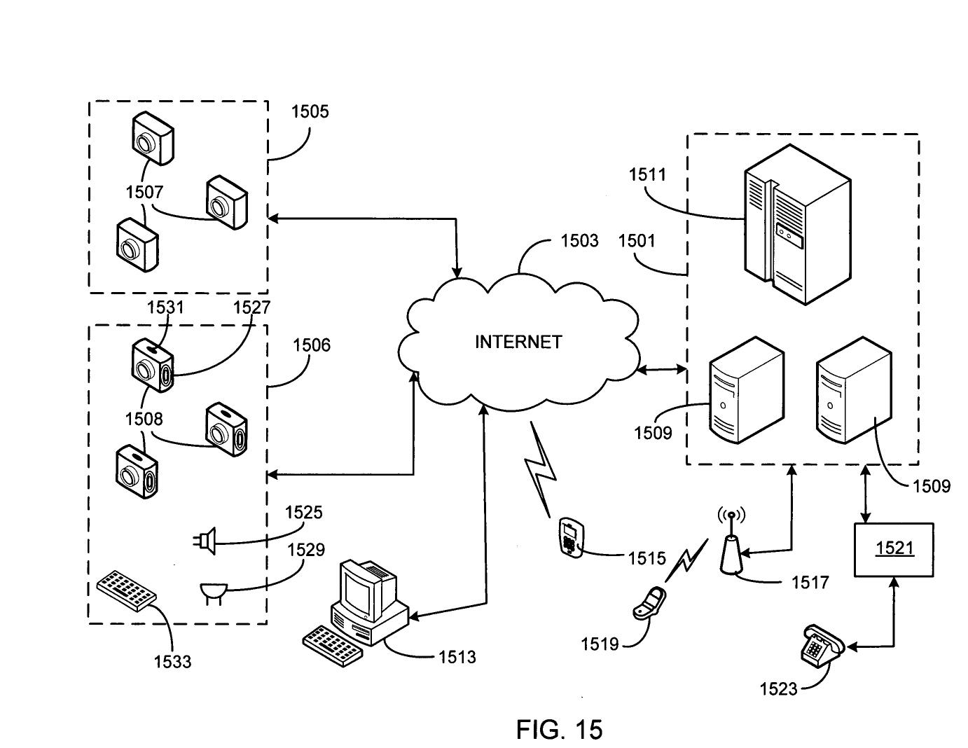

FIG. 15 is an illustration of an embodiment of the invention, the figure showing a variety of methods for notifying a system user of the status of the system. It will be appreciated that user notification can be set-up to notify the user in response to any of a variety of conditions, including providing periodic status reports, in response to an event triggering a default rule (e.g., motion detection in a closed area), or in response to an event triggering a geochronshape rule.

As shown in FIG. 15, a third party site 1501 is coupled to internet 1503. As previously described, the third party site is remotely located from the users and is used to store, analyze and handle the video data acquired by multiple, unrelated users (represented by users 1505 and 1506, utilizing cameras 1507 and 1508, respectively) and communicated to third party site 1501 via internet 1503. As previously noted, there are a variety of techniques, well known by those of skill in the art, for transmitting/receiving video data over the internet and therefore further detailed description is not provided herein.

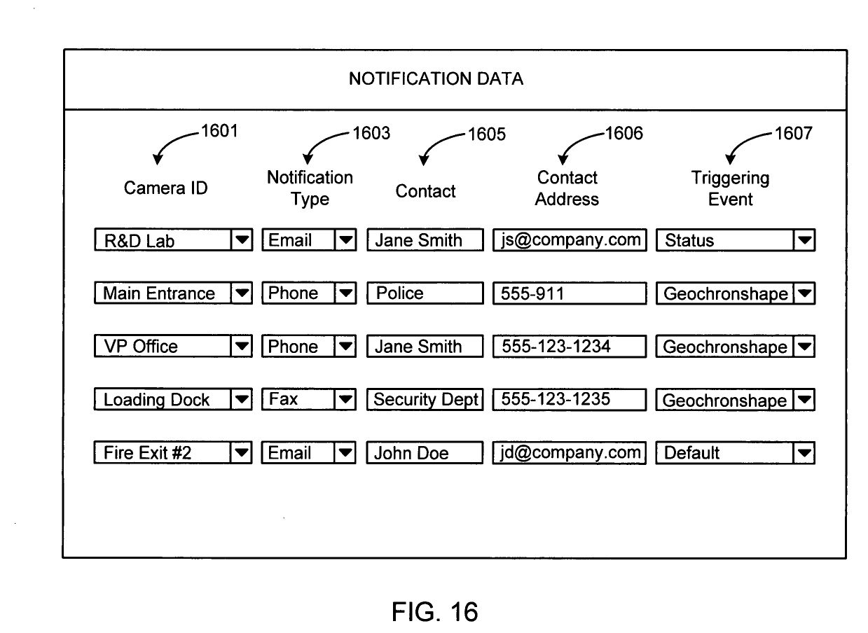

One or more servers 1509 and one or more storage devices 1511 are located at third party site 1501. In addition to communication and/or processing and/or analyzing video data as previously noted, servers 1509 are also used for system configuration and to transmit notification messages to the end users, locations/personnel designated by the end users, or both. The users, preferably using an input screen such as that illustrated in FIG. 16, designate for each camera identification 1601 (or for groups of identified cameras) the manner in which notification messages are to be sent (e.g., pull-down menu 1603), contact/address information 1605-1606, and the triggering event for receiving notification (e.g., pull-down menu 1607). A benefit of using a data input screen such as that shown in FIG. 16 is that it allows users, assuming they have been granted access, to remotely reconfigure the system as needed. Thus, for example, a user can remotely change from receiving notification messages via email to receiving an audio notification message on their cell phone.

As previously noted, third party site 1501 is coupled to internet 1503, thus allowing access by an internet coupled computers (e.g., desktop computer 1513), personal digital assistants (e.g., PDA 1515), or other wired/wireless devices capable of communication via internet 1503. Preferably third party site 1501 is also coupled to one or more telephone communication lines. For example, third party site 1501 can be coupled to a wireless communication system 1517, thus allowing communication to any of a variety of wireless devices (e.g., cell phone 1519). Third party site 1501 can also be coupled to a wired network 1521, thus allowing access to any of a variety of wired devices (e.g., telephone 1523).

Notification can either occur when the user/designee requests status information (i.e., reactive system), or in response to a system rule (i.e., proactive system). In the proactive approach the system can be responding to a user rule or a system default rule. Regardless of whether the notification message is a reactive message or a proactive message, preferably the message follows a set of user defined notification rules such as those illustrated in FIG. 16. If desired, the notification rules can be set-up to allow for a single triggering event to cause multiple messages to be sent to multiple parties and/or using multiple transmission means.

Textual Notification

In a preferred embodiment, the third party site of the invention notifies users or other user designees with a text message. Depending upon the system configuration and the requirements of the user, such text messaging can range from a simple alert message (e.g., “system breach”) to a message that provides the user/designee with detailed information regarding the triggering event (e.g., date, time, camera identification, camera location, triggered geochronshape rule, etc.). The text message can be sent via email, fax, etc. In one aspect of the invention, rather than actively sending the text message, the message is simply posted at an address associated with, or accessible by, the particular user/user designee, thus requiring that the user/designee actively look for such messages. This approach is typically used when the user/designee employs one or more personnel to continually review video imagery as the data is acquired.

Audio Notification

In a preferred embodiment, the third party site of the invention notifies users or other user designees with an audio message. Depending upon the system configuration and the requirements of the user, such audio messaging can range from a simple alert message (e.g., “the perimeter has been breached”) to a message that provides the user/designee with detailed information regarding the triggering event (e.g., “on Oct. 12, 2003 at 1:32 am motion was detected in the stairway outside of the loading dock”). The audio message can either be sent by phone automatically when the event in question triggers the geochronshape rule, default rule, etc., or the audio message can be sent in response to a user/designee status request. Although the system can use pre-recorded messages, preferably the system uses a voice synthesizer to generate each message in response to the triggering event.

Video Notification

In a preferred embodiment, the third party site of the invention notifies users or other user designees with a video message, preferably accompanying either an audio message or a text message. Typically the video aspect of the message includes a portion of the video imagery captured by the triggered camera, for example video images of the intruder who triggered an alarm. The video imagery may also include additional information presented in a visual format (e.g., location of the triggered camera on a map of the user's property). The video message can either be sent automatically when the event in question triggers the geochronshape rule, default rule, etc., or the video message can be sent in response to a user/designee status request, or the video message can simply be accessible to the user/designee at a web site (e.g., third party hosted web site to which each user/designee has access). The video data sent in the video notification can either be live camera data, camera data that has been processed, or some combination thereof.

As previously described in the specification, the preferred embodiment of the present invention includes video processing capabilities. For example, the system can be set-up to review acquired video images looking for specific shapes (e.g., a person, a gun-shaped object, etc.). This data review process can also be configured to be dependent upon the day of the week, the time of the day, or the location of the object within a video image. Accordingly such capabilities allow the notification system to react more intelligently than a simple breach/no breach alarm system. Thus the system is able to notify the user/designee of the type of security violation, the exact location of the violation, the exact time and date of the violation as well as provide imagery of the violation in progress. This processing system, as previously disclosed, can also enhance the image, for example by zooming in on the target, increasing the resolution of the image, etc. Such intelligent analysis capabilities decreases the likelihood of nuisance alarms.

Fully Automated Surveillance and Notification System

As described above, the present invention provides the user with the ability to set-up a variety of rules that not only control the acquisition of camera data, but also what events and/or objects violate the user defined rules. Additionally, the system can be set-up to automatically notify the user by any of a variety of means whenever the rules are violated. Therefore in a preferred embodiment of the invention, the data acquired by the user's cameras are automatically reviewed (i.e., no human review of the acquired data) and then, when the system determines that a violation of the user defined rules has occurred, the system automatically notifies (i.e., no human involvement) the user/designee according to the user-defined notification rules. The automated aspects of the invention can either reside locally, i.e., at the user's site, or remotely, i.e., at a third party site.

The benefits of a fully automated system, in other words a system that does not require human involvement during day to day operations, are numerous. First, after the initial set-up expense, the typical operational cost is much less than that of a system requiring personnel to monitor a bank of cameras and report possible security violations. Second, the automated system is a more reliable system as it is not prone to human error (e.g., falling asleep on the job or watching one camera monitor while a violation is occurring in the field of view of another camera). Third, there is no notification delay in an automated system as there often is in a non-automated system in which there may be both data review and data reporting errors/delays. Fourth, a fully automated system, or at least a system using a fully automated notification process, can easily and reliably send notification messages to different people, depending upon which camera is monitoring the questionable activity. Thus the person with the most knowledge about a particular area (e.g., loading dock foreman, office manager, VP of operations, etc.) receives the initial notification message or alarm and can decide whether or not to escalate the matter, potentially taking the matter to the authorities. This, in turn, reduces the reporting of false alarms.

Automated Interrogation System

In another embodiment, the automated surveillance system of the invention includes the ability to automatically interrogate a potential intruder. Although the software application for this embodiment is preferably located at the remotely located third party site, e.g., site 301 of FIG. 3 or site 1501 of FIG. 15, it will be appreciated that it could also operate on an on-premises system such as either system 405 or 407 shown in FIG. 4.

In operation once a potential intruder is detected, preferably using image recognition software and a set of rules such as the geochronshape rules described above, the system notifies the potential intruder that they are under observation and requests that they submit to questioning in order to determine if they are a trespasser or not. If the identified party refuses or simply leaves the premises, the automated system would immediately contact the party or parties listed in the notification instructions (e.g., authorities, property owner, etc.). If the identified party agrees to questioning, the system would ask the party a series of questions until the party's identity is determined and then take appropriate action based on the party's identity and previously input instructions (e.g., notify one or more people, disregard the intruder, etc.).

Preferably the questions are a combination of previously stored questions and questions generated by the system. For example, the system may first ask the intruder their identity. If the response is the name of a family member or an employee, the system could then ask appropriate questions, for example verifying the person's identity and/or determining why the person is on the premises at that time or at that particular location. For example, the intruder may be authorized to be in a different portion of the site, but not in the current location. Alternately, it may be after hours and thus at a time when the system expects the premises to be vacated. In verifying the intruder's identity, the system can use previously stored personnel records to ask as many questions as required (e.g., family members, address information, social security number, dates of employment, etc.).

FIG. 15 illustrates a couple of the ways in which the interrogation aspects of the invention can be performed. It will be appreciated that there are other obvious variants that can perform the same functions, depending upon system configuration, and that such elements can also be included in a local system (e.g., systems 405 or 407 of FIG. 4). The questioning by the system is preferably performed using a voice synthesizer resident on an application server (e.g., server 1509). Delivery of the synthesized voice can either use on-site speakers 1525 or use speakers 1527 co-located with, or more preferably internal to, cameras 1508. Preferably the potential intruder is allowed to vocally respond to the questions, thus allowing the system to analyze the voice using either voice recognition software or voice analysis software (to determine the possible mental state of the speaker) or both. In this embodiment the responses are either received by individual microphones 1529 or microphones 1531 co-located with, or more preferably internal to, cameras 1508. Although not preferred, responses can also be given on a keyboard/touchpad 1533.

Supplementation of Roving Security with Surveillance and Interrogation System

Operators of some premises, for example industrial sites, often require the use of roving security personnel, regardless of the level of surveillance afforded by cameras, alarm systems, etc. Typically such a system is implemented by providing each roving security person with a key that they use at a series of key boxes, the key boxes registering the time when the security person inserted their key in the key box, and thus passed by that particular key box location. One problem associated with such key box procedures is that the system does not realize if the security guard has been replaced (e.g., security guard sends a replacement, intruder replaces the guard, etc.).

The present system can be used to supplement a system that uses roving security personnel by replacing the key/key box combination with the video acquisition and analysis capabilities of the invention. In particular, the system can be set-up using the geochronshape rules to monitor a certain camera's field of view or field of view zone at specific times on particular days (e.g., 11 pm, 2 am, and 5 am everyday) for a particular image (e.g., a particular security guard). If the previously identified guard was not observed at the given times/days, or within a predetermined window of time, the notification feature could be used to notify previously identified parties (e.g., head of security, police, etc.).

In addition to insuring that the correct person is making the security rounds at the predetermined times, the system could also be set-up to ask one or more questions of the roving guard using interrogation systems such as those described above. The purpose of the questions could be to ascertain whether or not the guard was there of their own volition or under force by an intruder (e.g., using code words), to determine the conditions of the guard (e.g., sober, drunk) using response times, speech analysis, etc., or for other purposes. Given the ease by which the system can be updated, the identity of replacement guards could be easily and quickly input into the system. Furthermore using the interrogation techniques described above, even if the replacement guard had not been properly input into the system, the system could still automatically validate the replacement, for example by determining that the replacement was on an approved list of replacements and their identity was confirmed.

The use of infrared (IR) sensors, either as a supplement to the video cameras or as a replacement, could also be used to verify identity using IR signatures. Additionally IR emitters, for example with special emission frequencies or patterns, could be used for identity verification.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

1. A method of storing, analyzing and accessing video data, the method comprising the steps of:
transmitting video data from at least one surveillance camera at a first user site to a remotely located third party site via a network, wherein said first user site is independent of said remotely located third party site;
transmitting video data from at least one surveillance camera from at least one additional user site to said remotely located third party site via said network, wherein said at least one additional user site is independent of said first user site and said remotely located third party site;
analyzing said video data from said first user and said at least one additional user by an application located on a server at said third party site;
storing said analyzed video data from said first user and said at least one additional user in a video data base located at said third party site; and
accessing said analyzed video data stored in said video data base located at said third party site via a user controlled device coupled to said network and located remotely from said third party site.

2. The method of claim 1, wherein said network is an internet based network.

3. The method of claim 1, further comprising the steps of coupling said at least one surveillance camera of said first user site to a local area network and coupling said local area network to said network.

4. The method of claim 1, wherein said user controlled device is a network connected computer.

5. The method of claim 1, further comprising the step of compressing said video data from said at least one surveillance camera at said first user site prior to transmitting said video data from said at least one surveillance camera at said first user site to said remotely located third party site.

6. The method of claim 1, further comprising the step of storing said video data from said first user in a second video data base located at said first user site.

7. The method of claim 1, further comprising the step of inputting user video data base configuration instructions to said third party site via said network using an input device remotely located from said third party site.

8. The method of claim 7, further comprising the step of selecting said user video data base configuration instructions from the group consisting of data storage time, data acquisition frequency, data communication parameters and video resolution.

9. The method of claim 7, wherein said user video data base configuration instructions are camera specific.

10. The method of claim 1, further comprising the steps of:
inputting a user request for a graphical view of activity versus time for a specific user camera, said user request input to said third party site via said network using an input device remotely located from said third party site;
determining activity versus time for said specific user camera, said step performed by said application located on said server at said third party site; and
transmitting said requested graphical view of activity versus time for said specific user camera to said input device via said network from said third party site.

11. The method of claim 10, further comprising the step of inputting a period of time for analysis to said third party site via said network using said input device.

12. The method of claim 10, further comprising the steps of:
identifying a portion of said graphical view of activity versus time for said specific user camera;
transmitting said identified portion of said graphical view of activity versus time for said specific user camera to said third party site via said network using said input device; and
transmitting video data corresponding to said identified portion of said graphical view of activity versus time for said specific user camera to said input device via said network from said third party site.

13. The method of claim 1, further comprising the steps of:
inputting at least one user defined rule of analysis to be applied to a specific user camera, said user defined rule of analysis input to said third party site via said network using an input device remotely located from said third party site; and
analyzing said video data in accordance with said at least one user defined rule of analysis for said specific user camera, said step performed by said application located on said server at said third party site.

14. The method of claim 13, further comprising the step of transmitting video data analyzed in accordance with said at least one user defined rule of analysis for said specific camera from said third party site to said input device via said network.

15. The method of claim 13, wherein said at least one user defined rule of analysis includes a plurality of time period based rules.

16. The method of claim 13, wherein said at least one user defined rule of analysis includes at least one shape based rule.

17. The method of claim 13, further comprising the step of selecting an autofocus feature to be applied to said specific user camera, wherein said selecting step is input to said third party site via said network using a second input device remotely located from said third party site.

18. The method of claim 17, wherein said autofocus feature comprises the steps of:
determining when one of said at least one user defined rule of analysis is triggered; and
increasing a resolution corresponding to said specific user camera.

19. The method of claim 17, wherein said input device and said second input device are the same device.

20. The method of claim 1, further comprising the steps of:
inputting a user zone instruction to divide a field of view corresponding to a specific camera into a plurality of zones, said user zone instruction input to said third party site via said network using an input device remotely located from said third party site;
inputting a plurality of user defined rules of analysis corresponding to said plurality of zones to said third party site via said network using said input device; and
analyzing said plurality of zones of said video data for said specific user camera in accordance with said plurality of user defined rules of analysis, said analyzing step performed by said application located on said server at said third party site.

21. The method of claim 20, further comprising the step of transmitting video data analyzed in accordance with said plurality of user defined rules of analysis for said specific camera from said third party site to said input device via said network.

22. The method of claim 20, wherein said plurality of user defined rules of analysis include a plurality of time period based rules.

23. The method of claim 20, wherein said plurality of user defined rules of analysis include at least one shape based rule.

24. The method of claim 20, further comprising the steps of selecting an autozoom feature to be applied to said plurality of zones of said video data for said specific user camera, wherein said selecting step is input to said third party site via said network using a second input device remotely located from said third party site.

25. The method of claim 24, wherein said autozoom feature comprises the steps of:
determining when one of said plurality of user defined rules of analysis is triggered;
identifying a specific zone of said plurality of zones in which said one of said plurality of user defined rules of analysis was triggered; and
enlarging said specific zone of said plurality of zones.

26. The method of claim 25, wherein said enlarging step enlarges said specific zone to fill said field of view of said specific user camera.

27. The method of claim 24, wherein said input device and said second input device are the same device.

28. The method of claim 20, further comprising the steps of selecting an autofocus feature to be applied to said plurality of zones of said video data for said specific user camera, wherein said selecting step is input to said third party site via said network using a second input device remotely located from said third party site.

29. The method of claim 28, wherein said autofocus feature comprises the steps of:
determining when one of said plurality of user defined rules of analysis is triggered;
identifying a specific zone of said plurality of zones in which said one of said plurality of user defined rules of analysis was triggered; and
increasing a resolution corresponding to said specific zone of said plurality of zones.

30. The method of claim 28, wherein said input device and said second input device are the same device.

31. A method of storing, analyzing and accessing video data, the method comprising the steps of:
transmitting video data from a first plurality of surveillance cameras located at a first user site to a remotely located third party site via an internet network, wherein said first user site is independent of said remotely located third party site;
inputting a first user video base configuration instruction for said first user site to said third party site via said internet network using a first input device remotely located from said third party site;
inputting a first user defined rule of analysis to be applied to at least one of said first plurality of surveillance cameras, wherein said first user defined rule of analysis is input to said third party site via said internet network using a second input device remotely located from said third party site;
analyzing said video data from said at least one of said first plurality of surveillance cameras in accordance with said first user defined rule of analysis, said analyzing step performed by an application located on a server at said third party site;
storing said analyzed video data from said at least one of said first plurality of surveillance cameras in accordance with said first user video base configuration instruction in a video data base located at said third party site;
accessing said analyzed video data from said at least one of said first plurality of surveillance cameras stored in said video data base via a first user controlled access device coupled to said internet network and located remotely from said third party site;
transmitting video data from a second plurality of surveillance cameras at a second user site to said remotely located third party site via said internet network, wherein said second user site is independent of said first user site and said remotely located third party site;
inputting a second user video base configuration instruction for said second user site to said third party site via said internet network using a third input device remotely located from said third party site;
inputting a second user defined rule of analysis to be applied to at least one of said second plurality of surveillance cameras, wherein said second user defined rule of analysis is input to said third party site via said internet network using a fourth input device remotely located from said third party site;
analyzing said video data from said at least one of said second plurality of surveillance cameras in accordance with said second user defined rule of analysis, said analyzing step performed by said application located on said server at said third party site;
storing said analyzed video data from said at least one of said second plurality of surveillance cameras in accordance with said second user video base configuration instruction in said video data base located at said third party site; and
accessing said analyzed video data from said at least one of said second plurality of surveillance cameras stored in said video data base via a second user controlled access device coupled to said internet network and located remotely from said third party site.

32. The method of claim 31, further comprising the steps of coupling said first plurality of surveillance cameras to a local area network and coupling said local area network to said internet network.

33. The method of claim 31, wherein said first and second input devices are the same device.

34. The method of claim 31, wherein said first input device and said first user controlled access device are the same device.

35. The method of claim 31, further comprising the step of compressing said video data from said first plurality of surveillance cameras prior to transmitting said video data from said first user site to said remotely located third party site.

36. The method of claim 31, further comprising the step of storing said video data from said first plurality of surveillance cameras in a second video data base located at said first user site.

37. The method of claim 31, further comprising the step of selecting said first user video data base configuration instruction from the group consisting of data storage time, data acquisition frequency, data communication parameters and video resolution.

38. The method of claim 31, wherein said first user video data base configuration instruction is camera specific.

39. The method of claim 31, further comprising the steps of:
inputting a first user request for a graphical view of activity versus time for a specific first user camera of said first plurality of surveillance cameras, said first user request input to said third party site via said internet network using a fifth input device remotely located from said third party site;
determining activity versus time for said specific first user camera, said step performed by said application located on said server at said third party site; and
transmitting said requested graphical view of activity versus time for said specific first user camera to said fifth input device via said internet network from said third party site.

40. The method of claim 39, further comprising the step of inputting a period of time for analysis to said third party site via said internet network using said fifth input device.

41. The method of claim 39, further comprising the steps of:
identifying a portion of said graphical view of activity versus time for said specific first user camera;
transmitting said identified portion of said graphical view of activity versus time for said specific first user camera to said third party site via said internet network using said fifth input device; and
transmitting video data corresponding to said identified portion of said graphical view of activity versus time for said specific first user camera to said fifth input device via said internet network from said third party site.

42. The method of claim 31, wherein said first user defined rule of analysis includes a plurality of time period based rules.

43. The method of claim 31, wherein said first user defined rule of analysis includes at least one shape based rule.

44. The method of claim 31, further comprising the step of selecting an autofocus feature to be applied to said at least one of said first plurality of user cameras, wherein said selecting step is input to said third party site via said internet network using a fifth input device remotely located from said third party site.

45. The method of claim 44, wherein said autofocus feature comprises the steps of:
determining when said first user defined rule of analysis is triggered; and
increasing a resolution corresponding to said at least one of said first plurality of user cameras.

46. The method of claim 31, further comprising the steps of:
inputting a first user zone instruction to divide a field of view corresponding to a specific user camera of said first plurality of cameras into a plurality of zones, said user zone instruction input to said third party site via said internet network using a fifth input device remotely located from said third party site, wherein said first user defined rule of analysis is comprised of a plurality of rules corresponding to said plurality of zones; and
analyzing said plurality of zones of said video data for said specific user camera in accordance with said plurality of rules, said analyzing step performed by said application located on said server at said third party site.

47. The method of claim 46, further comprising the step of transmitting video data analyzed in accordance with said plurality of rules and said plurality of zones for said specific user camera from said third party site to a third user controlled access device via said internet network.

48. The method of claim 46, wherein said first user defined rule of analysis includes a plurality of time period based rules.

49. The method of claim 46, wherein said first user defined rule of analysis includes at least one shape based rule.

50. The method of claim 46, further comprising the steps of selecting an autozoom feature to be applied to said plurality of zones of said video data for said specific user camera, wherein said selecting step is input to said third party site via said internet network using a sixth input device remotely located from said third party site.

51. The method of claim 50, wherein said autozoom feature comprises the steps of:
determining when said first user defined rule of analysis is triggered;
identifying a specific zone of said plurality of zones in which said first user defined rule of analysis is triggered was triggered; and
enlarging said specific zone of said plurality of zones.

52. The method of claim 51, wherein said enlarging step enlarges said specific zone to fill said field of view of said specific user camera.

53. The method of claim 46, further comprising the steps of selecting an autofocus feature to be applied to said plurality of zones of said video data for said specific user camera, wherein said selecting step is input to said third party site via said internet network using a sixth input device remotely located from said third party site.

54. The method of claim 53, wherein said autofocus feature comprises the steps of:
determining when said first user defined rule of analysis is triggered;
identifying a specific zone of said plurality of zones in which said first user defined rule of analysis was triggered; and
increasing a resolution corresponding to said specific zone of said plurality of zones.
